(19) United States
(12) Patent Application Publication
(10) Pub. No.: US 2018/0350474 A1
(43) Pub. Date: Dec. 6, 2018

(54) RECTANGULAR NUCLEAR REACTOR CORE

(71) Applicant: Ian Richard SCOTT, Warwickshire (GB)

(72) Inventor: Ian Richard SCOTT, Warwickshire (GB)

(21) Appl. No.: 15/778,624

(22) PCT Filed: Dec. 6, 2016
(86) PCT No.: PCT/GB2016/053837

§ 371 Date: May 23, 2018

(30) Foreign Application Priority Data
Dec. 6, 2015 (GB) 1521490.1
Dec. 6, 2015 (GB) 1521491.9

(51) Int. Cl. G21C 19/20; G21C 3/324; G21C 3/328; G21C 3/54; G21C 5/12; G21C 3/322

(52) U.S. Cl. CPC G21C 19/205; G21C 3/3245; G21C 3/328; G21Y 2004/30; G21C 5/126; G21C 3/322; G21Y 2002/402; G21C 3/54

(57) ABSTRACT

A method of operating a nuclear fission reactor, the reactor comprising a reactor core, and a coolant tank containing coolant, the reactor core comprising an array of fuel assemblies arranged in generally parallel rows, each fuel assembly comprising one or more fuel tubes containing fissile fuel. For each row of the array, one or more spent fuel assemblies are removed from the array at a second end of the row, fuel assemblies are moved along the row from a first end to the second end; and one or more fuel assemblies are introduced to the array at the first end of the row. Each fuel assembly remains within a single row while the fuel assembly is within the array. At least the fuel-filled portions of the fuel tubes of each fuel assembly are immersed in the coolant while the fuel assembly is within the array.

### TECHNICAL FIELD

The present invention relates to a simple procedure to maintain reactivity in a nuclear reactor core as fissile isotopes are consumed by replacement of spent fuel assemblies with fresh ones.

### BACKGROUND

The cores of nuclear reactors are generally cylindrical in shape so as to minimise the ratio of surface area to volume and hence the rate of neutron leakage. Rectangular cores have been proposed, for example the Russian RBMK2400 (A. P. Aleksandrov, N. A. Dollezhal Soviet Atomic Energy 43,985) but have rarely if ever been constructed.

Nuclear reactors containing cores formed from assemblies of tubes containing molten salt fuel have been described in GB2508537. Such reactors have substantial advantages over solid fuelled reactors. Replacement of spent fuel assemblies with fresh ones is one mechanism used to maintain the reactivity of the core as fissile isotopes are consumed and methods to do this without raising the fuel assemblies out of the core are described in WO 2015/166203. The approach described in WO 2015/166203 generally involves gradual migration of the fuel assemblies towards the centre of the reactor core, followed by relatively rapid movement out of the core along an “exit row”. Achieving this requires a fuel assembly moving apparatus capable of moving assemblies in two horizontal directions, a relatively mechanically complex procedure.

### SUMMARY

A method of maintaining reactivity by moving fuel assemblies in a single direction would be advantageous due to the greater mechanical simplicity of a system required to do that but would be most inefficient in a cylindrical reactor core, not permitting uniform or high burnup of the nuclear fuel.

According to a first aspect there is provided a method of operating a nuclear fission reactor, the reactor comprising a reactor core, and a coolant tank containing coolant, the reactor core comprising an array of fuel assemblies arranged in generally parallel rows, each fuel assembly comprising one or more fuel tubes containing fissile fuel. For each row of the array, one or more spent fuel assemblies are removed from the array at a second end of the row, fuel assemblies are moved along the row from a first end to the second end; and one or more fuel assemblies are introduced to the array at the first end of the row. Each fuel assembly remains within a single row while the fuel assembly is within the array. At least the fuel-filled portions of the fuel tubes of each fuel assembly are immersed in the coolant while the fuel assembly is within the array.

According to a further aspect, there is provided a nuclear fission reactor. The reactor comprises a core, a coolant tank containing coolant, and a fuel assembly moving unit. The core comprises an array of fuel assemblies arranged in parallel rows, each fuel assembly comprising one or more fuel tubes containing fissile fuel. The fuel assembly moving unit is configured, for each row of the array:
to remove one or more spent fuel assemblies from the array at a second end of the row;
to move fuel assemblies along the row from a first end to the second end; and
to introduce fuel assemblies to the array at a first end of the row.

The fuel assembly moving unit is configured to perform this movement such that each fuel assembly remains within a single row while the fuel assembly is within the array; and such that at least the fuel-filled portions of the fuel tubes of each fuel assembly are immersed in the coolant while the fuel assembly is within the array.

### BRIEF DESCRIPTION OF THE DRAWINGS

FIG. 1 is a top view of a rectangular reactor core demonstrating the migration of fuel assemblies in opposite directions in alternate rows.

FIG. 2 is a side view of an example of a bottom catch being a spike at the bottom of the fuel assembly that locates into a corresponding hole is a supporting diagrid.

FIG. 3 shows an example of a top catch that allows spring pressure to hold down and positively locate the assembly under normal conditions while allowing its movement when required.

FIG. 4 shows an example of how fission rate and average fissile concentration vary across a reactor core

FIG. 5 shows a cross section of a fuel assembly containing a graphite core

FIG. 6 shows the power distribution across a rectangular reactor core where 66% fuel burnup was achieved

FIG. 7 shows an illustration of a reactor structure showing the mechanisms for moving fuel assemblies and removing or inserting them into the core

### DETAILED DESCRIPTION

“Parallel” is used herein without reference to the direction of motion along parallel lines—i.e. “parallel” includes “antiparallel”, where two features are parallel but oriented in opposite directions.

The reactor core consists of a number of fuel assemblies comprising a multiplicity of tubes containing the molten salt nuclear fuel. The assemblies are at least partly immersed in a coolant medium, which may be a second molten salt or may be another liquid coolant such as a molten metal such as sodium, potassium, lead, bismuth or mixtures thereof. The coolant is at such a level as to completely cover the fuel filled regions of the fuel assembly. The structure of the assembly can be similar to those extensively developed for solid fuelled reactors. The assemblies are of approximately square or rectangular cross section, although other cross sections permitting assemblies to fit closely together while being able to be moved along the row of assemblies are possible, including triangular sections.

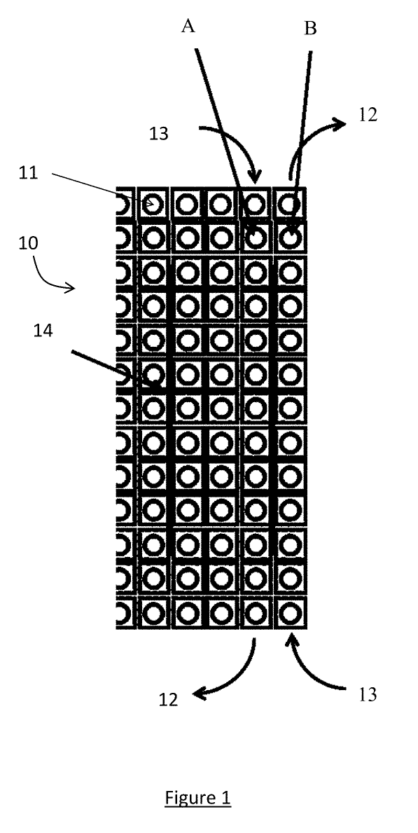

FIG. 1 is a top view of an array 10 of fuel assemblies 11 are arranged in a rectangular array of parallel rows A,B. Spent fuel assemblies are removed from one end 12 of each row and new fuel assemblies are inserted at the other end 13, with the fuel assemblies in between moving along the row. There may be control blades 14 located between the rows, as described in more detail later.

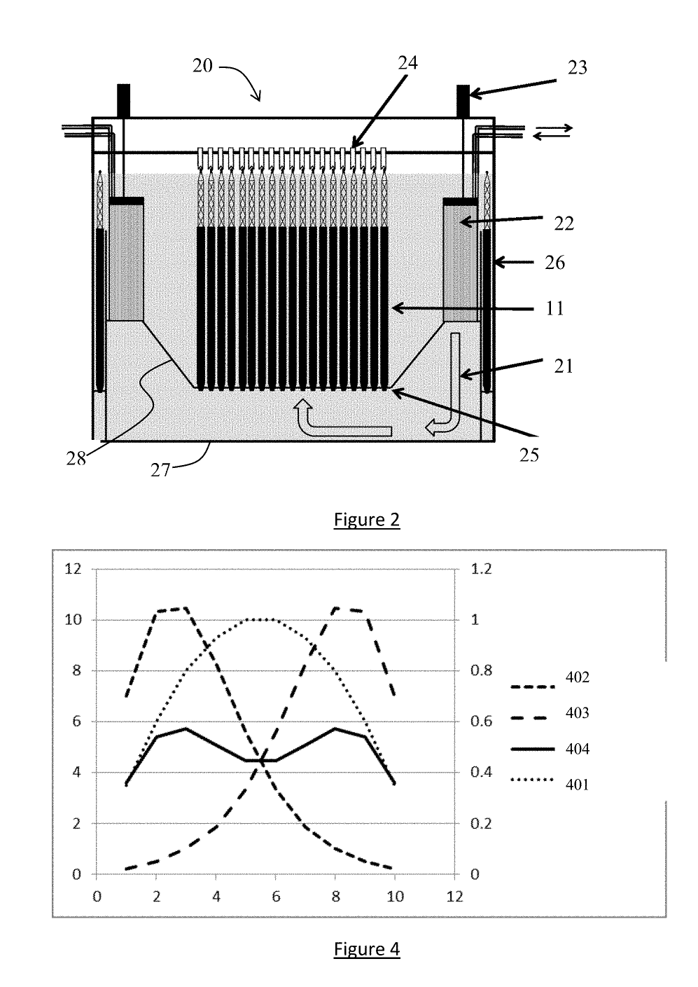

FIG. 2 shows an exemplary reactor 20 incorporating the array of fuel assemblies 11. The reactor comprises a coolant tank 27 containing coolant salt 21, a core comprising the array of fuel assemblies 11, and a heat exchanger 22, driven by a motor 23. Spent fuel assemblies 26 are moved away from the main reactor core to a holding area until they are cool enough to safely remove from the coolant. The fuel assemblies are securely supported from the top and bottom by top 24 and bottom 25 catches. Fuel assemblies are moved across the row by disengaging the top and bottom catches then moving the assembly to the next location in the row. Many mechanisms can be envisioned for achieving this, and one is illustrated in FIG. 2 where the bottom catch is a conical/pyramidal “spike” at the bottom of the assembly which locates in a corresponding hole in a support grid 28, (hereinafter referred to as the diagrid), below the core. The catch is disengaged by raising the fuel assembly a short distance, prior to moving it laterally and reinserting the spike into the next hole in the diagrid. A suitable mechanism for the top catch is shown in FIG. 3. This mechanism incorporates springs which hold the fuel assembly firmly in the diagrid against any buoyancy forces together with pegs that firmly anchor the top of the assembly into the supporting top grid structure. The pegs are disengaged and the springs fully compressed by vertical pressure from the fuel assembly moving machine which then locks the springs in the fully compressed position prior to raising the fuel assembly sufficiently to disengage the bottom catch and then moving the assembly laterally.

Spent fuel assemblies are removed from the end of their row of assemblies by the same movement system. They are then moved away from the core. Optionally they can be moved laterally sufficiently far from the core to be out of the intense neutron flux and allowed to cool while still immersed in the coolant until decay heat has fallen sufficiently for them to be safely raised out of the coolant and the reactor tank. When a spent fuel assembly has been removed, the remaining fuel assemblies in that row are migrated by one position leaving a gap at the opposite end of the row. A fresh fuel assembly is then inserted in that gap.

Control of the core reactivity can be entirely by passive means, based on the high negative temperature coefficient of reactivity of molten salt fuel. However it can be convenient to provide neutron absorbing shut down or control elements. These can be located as blades of neutron absorbing material which can be inserted between adjacent rows of fuel assemblies. Standard fail safe electromagnetic systems as used in most reactor control rods can be used to control the blade position.

Movement of fuel assemblies can be carried out while the reactor is operational provided that adequate heat removal from the fuel assembly can be maintained during the process. Alternatively the reactor can be shut down during the fuel changing process or control blades can be used to decrease the power level in a particular row or rows of fuel assemblies while allowing the core as a whole to remain critical.

Movement of the fuel assemblies can be simplified by providing the fuel assemblies with an upper region above the level of the fuel tubes which is narrower that the main part of the fuel assembly. This provides space for support structures separating the rows of fuel assemblies from their neighbouring rows. It also creates space above the fuel filled portion of the reactor core for instrumentation including neutron and temperature sensors to be placed close to the active region of the core.

It will be appreciated that fuel assemblies can be migrated along the rows either individually (so that, if an assembly is removed from one end of the row, the adjacent assembly is moved into the vacated space, etc.), or simultaneously (so that a whole set of assemblies is moved and then the assembly at the end of the row removed).

The principal purpose of the migration of adjacent fuel assembly rows in opposite directions is to maintain an approximately uniform average concentration of fissile isotopes within the reactor core. Migration in a single direction is possible, but would result in high power and neutron flux on one side of the core and low power and neutron flux on the other side. Other movement schemes for fuel assembly rows may also be used—for example alternating rows AABB (where A denotes one direction of movement, and B denotes the opposite direction), or some other scheme where a first set of rows moves in one direction and a second set moves in the other direction.

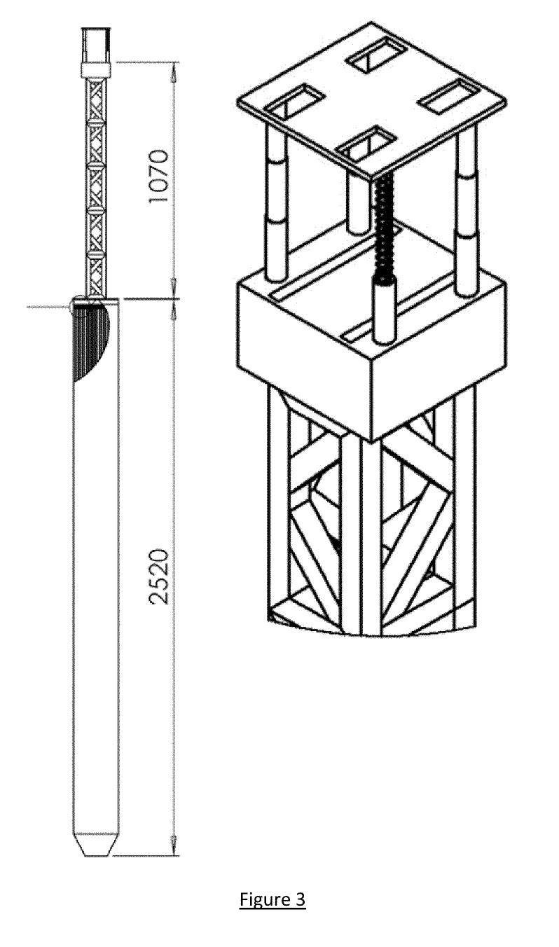

FIG. 4 illustrates how this is achieved. Curve 401 shows the distribution of neutron flux across the core. Curve 402 and 403 show the fission rate across the two adjacent rows. Curve 404 shows the average fission rate between two assemblies in adjacent rows across the core. It can be seen that the consequence of the migration of the rows of assemblies in opposite directions is a relatively flat average fission rate across the core.

Multiple rows of fuel assemblies can be incorporated into modules which can contain the fuel assembly support structure, assembly moving apparatus, heat exchangers, pumps, instrumentation etc. These modules can be assembled into longer rectangular reactors providing a simple method to create reactors of differing power levels with similar, potentially factory manufactured and assembled, modules.

The fuel tubes can be of a range of diameters from 5 mm to 50 mm. The narrower the tube the higher the permissible power level with the minimum fuel tube diameter being dictated by the thermo-physical properties of the molten salt fuel. If the tube is too narrow, convective heat flow is prevented and the permissible power level falls.

It is also beneficial to adapt the fuel assemblies to include a moderator. Use of graphite as moderator is well known in nuclear reactors, having been used extensively in reactors such as the Russian RBMK and UK AGR reactors. In all cases, the graphite is used as the main structural element in the reactor core, with fuel assemblies inserted into holes in the graphite matrix. Graphite used within the fuel assembly itself (as in the UK AGR) is present primarily as a structural component with the bulk of graphite responsible for the moderation of neutrons being in the core structure into which the fuel assemblies are inserted.

This arrangement is seen as desirable as a high volumetric fraction of graphite is required in a reactor core to achieve adequate neutron moderation. Such reactors must run at low power density (kW of heat per unit volume of reactor core) due to the neutron induced damage to the graphite which limits the reactor life at high power densities.

In molten salt fuelled reactors, graphite has been the material of choice as moderator. In pumped molten salt reactors the molten salt fuel is typically pumped through channels in the graphite. The relatively high power density of such reactors necessitates frequent replacement of the graphite which is a major challenge in reactor design.

Such use of graphite carries a substantial penalty however. The graphite absorbs fission products and hence becomes significantly radioactive making disposal challenging and expensive. The graphite also prevents the molten salt being maintained at a strongly reducing redox potential, which is desirable to minimise metal corrosion, due to reaction of the graphite to form carbides.

GB2508537 described the possibility of replacing some molten salt fuel tubes in a reactor core comprising such fuel tubes with graphite tubes. However, this method itself carries serious limits since large numbers of graphite tubes would present a large surface area for reaction with molten salts and, if clad with protective metal, would increase the parasitic neutron capture in the core to a level making very high concentrations of fissile isotopes necessary to achieve criticality.

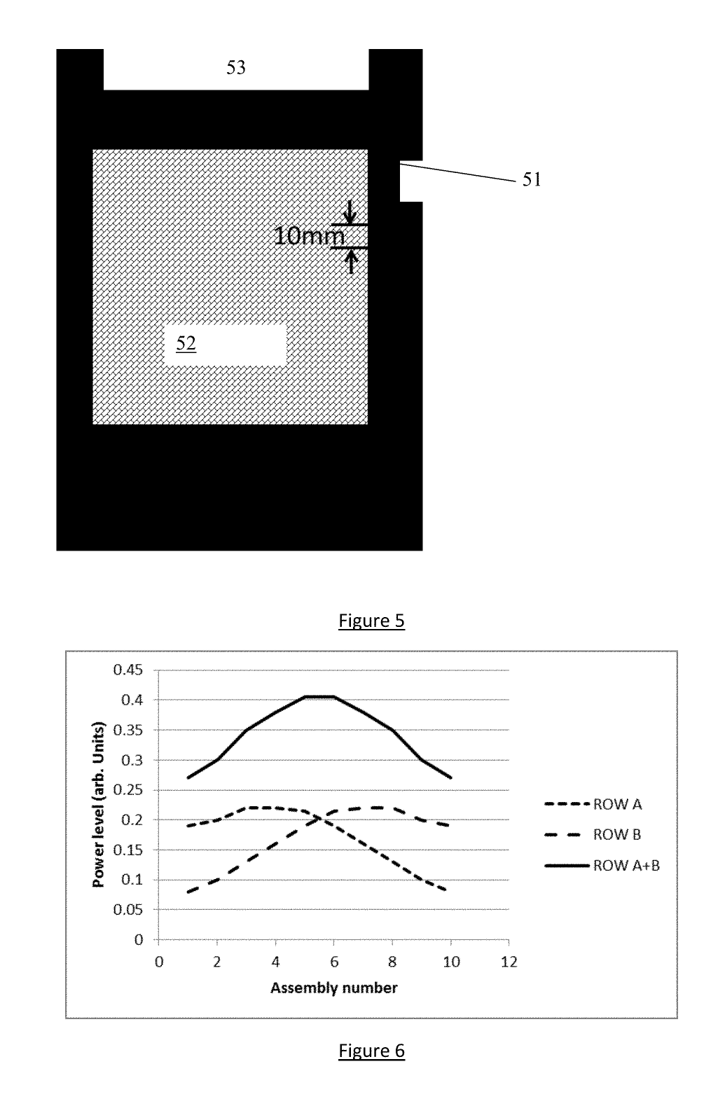

These problems can be addressed if the fuel assemblies themselves include neutron moderating materials such as graphite or zirconium hydride. Such reactors will operate in a thermal or epithermal neutron mode. Replacement of the moderator at the same time as the fuel overcomes the otherwise substantial problem of short life of materials such as graphite and zirconium hydride in intense neutron fields. An example of such a fuel assembly is provided in FIG. 5, where the fuel assembly has a plurality of fuel tubes 51 surrounding a graphite core 52.

The moderator core 52 may be clad in a molten salt resistant material 53, for example a metal alloy (such as stainless steel). a ceramic (such as silicon carbide), or other suitable material. The moderator can be any low atomic weight solid material with low neutron absorption, including carbon, zirconium hydride, zirconium deuteride, yttrium hydride or deuteride, lithium hydride or deuteride, beryllium oxide or other materials known as solid moderators.

The fuel assembly can optionally be clad overall in a molten salt resistant material (as is shown in the example of FIG. 5).

It is advantageous to have a single layer of fuel tubes surrounding the moderator core so that all tubes experience a similar flux of neutrons. However, multiple layers can be used where necessary. It can be advantageous where a double layer of tubes is used that the tubes be U shaped with one leg of the U in the inner layer and the other leg in the outer layer of tubes. Since fuel salt mixes between the two legs of the U tube, uniform fissile consumption is still achieved even though the two layers of tubes experience different neutron fluxes.

The moderator core may be applied to fuel assemblies of other cross sections, including hexagonal sections, for use with different fuel assembly array arrangements (e.g. those disclosed in WO 2015/166203).

While an arrangement of a central core of moderator surrounded by a layer or layers of fuel tubes is convenient, it is possible to form a a fuel assembly using other arrangements of moderator and fuel tubes. One example includes a central zone of fuel tubes surrounded on all sides by a layer of moderator. What is important is that all, or a large fraction, e.g. at least 75% or at least 50%, of the moderator in the reactor core is included in the fuel assembly.

### EXAMPLE 1

A rectangular fast reactor core was constructed in a neutronic computer model. The analysis was performed using MCNPX for neutron transport simulation. Neutron scattering cross sections were sampled from the ENDF/B-VII.1 libraries. Fission product composition was calculated from MCNPX simulations using the ENDF/B-VII.0 which have CINDER90 transmutation library information. The simulation results were analysed and plotted utilizing the CERN ROOT Framework.

The fuel tubes have an external diameter of 10 mm and a separation distance of a minimum of 1 mm in the lattice is ensured by a 1 mm diameter helically wrapped wire. The tube wall thickness is 0.316 mm. The fuel tubes are modelled as 204 cm tall tubes (outer)containing 160 cm fuel and a 40 cm void (gas plenum) above and two 2 cm thick tube end plugs. The helically wrapped wire is modelled as a vertical cylinder of diameter 1 mm aligned along the tube.

In addition to the coolant salt between tubes, a 100 cm coolant salt layer is modelled above and below the fuel tubes to act as a reflector. Both the tube and the wire are made from the metal Nimonic PE16. In this study the following low concentration elements are omitted from the PE16 material model: S, Ag, Bi, Pb, and Zr (boron is modelled, despite its low concentration). Material temperatures and densities are modelled as constant everywhere. Coolant salt is modelled as 41ZrF4-1ZrF2-10NaF-48KF with a density of 2.77 g cm−3, and cross sections are based on a 600 KENDF/B-VII.0 scattering database Doppler broadened to 773 K. Structural PE16 uses a 900 K ENDF/B-VII.0 database with no broadening and has a density of 8.00 g cm−3.

Fuel salt is modelled at a density of 3.1748 g cm⁻³ using a 900 K database Doppler broadened to 1103 K. The fuel salt is a close-to-eutectic mixture of 60% NaCl with different fractions of UCl3, PUCl3, and fission products depending on initial composition and burnup level. No thermal neutron treatment scattering kernel has been applied, the effect of such thermal treatment is expected to be insignificant as this reactor is a fast reactor. The fuel assemblies are modelled as 201×199.0 mm2 hexagonal lattice, containing fuel tubes arranged in a tightly packed hexagonal array of 18×21. The core tubes in two neighbouring assemblies have a minimum separation distance of 2 mm. The core was modelled as a cuboid consisting of 10×19 assemblies (10 ‘wide’, 19 ‘long’). ¼ symmetry was assumed, using reflective boundaries. A 1 m layer of coolant salt is modelled on all sides of the core.

The simulation was based on a 66% consumption of initial fissile atoms during the period when the fuel assembly moved across the core (10 steps). Initial fuel composition was 16 mol % reactor grade plutonium trichloride, 24% natural uranium trichloride and 60% sodium chloride. Initial fissile concentration was 11.5% Pu-239/241 and this reduced to 3.8% in the spent fuel.

FIG. 6 shows the average power density in the 10 assemblies along one row of assemblies (ROW A) together with the power density in the neighbouring row (ROW B) where assemblies are migrated in the opposite direction. Also shown is the sum of the power densities in the adjacent rows (ROW A+B) which indicates the distribution of average power density across the width of the entire core.

Power density for the individual fuel assembly is sustained at a relatively constant level until the assembly passes the mid point of the core. After this, power density falls significantly, over 50%, due to the combination of falling fissile isotope concentration and reduced neutron flux. Averaged over the adjacent rows however the power density peaks at the centre of the core but declines only by 33% at the edges of the core, an acceptably flat power distribution. At higher fissile isotope burnup, the average power does not peak at the centre line of the core but in two regions either side of the centre line.

### EXAMPLE 2

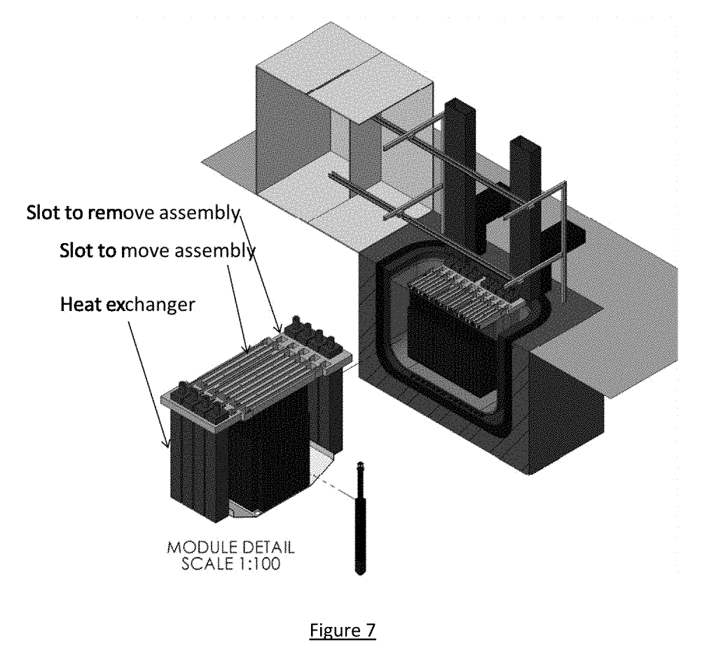

FIG. 7 shows a possible configuration of a rectangular core reactor with counter flow movement of fuel assemblies. Narrow slots in the reactor lid above the fuel assemblies are used to positively locate the upper catch of the fuel assembly while permitting lateral movement of the assembly when the catch is disengaged. Wider slots at each end of the narrow slots allow fuel assemblies to be inserted into and removed from the reactor tank.

1. A method of operating a nuclear fission reactor, the reactor comprising a reactor core, and a coolant tank containing coolant, the reactor core comprising an array of fuel assemblies arranged in generally parallel rows, each fuel assembly comprising one or more fuel tubes containing fissile fuel and each fuel assembly being elongate in a direction perpendicular to the rows, the method comprising:
for each row of the array:
removing one or more spent fuel assemblies from the array at a second end of the row;
moving fuel assemblies along the row from a first end to the second end; and
introducing one or more fuel assemblies to the array at the first end of the row;
wherein:
each fuel assembly remains within a single row between introduction of the fuel assembly to the array and removal of the fuel assembly from the array; and
at least the fuel-filled portions of the fuel tubes of each fuel assembly are immersed in the coolant between introduction of the fuel assembly to the array and removal of the fuel assembly from the array.

2. A method according to claim 1, wherein fuel assemblies in a first set of rows are moved in the opposite direction to fuel assemblies in a second set of rows.

3. A method according to claim 2, wherein a number of rows in the first set is substantially similar to the number of rows in the second set.

4. A method according to claim 3, wherein the rows of fuel assemblies alternate between rows in the first set and rows in the second set, such that fuel assemblies in adjacent rows move in opposite directions.

5. A method according to claim 1, wherein the steps of introducing, moving, and removing fuel assemblies occur during one or both of:
a power generation period of the reactor;
a shutdown period of the reactor.

6. A method according to claim 1, and comprising lowering control blades comprising a neutron absorbing material between rows in order to reduce power generated by a row in which fuel assemblies are being moved.

7. A method according to claim 1, wherein the array is rectangular.

8. A method according to claim 1 wherein one or both of the coolant and the fissile fuel is a molten salt.

9. A nuclear fission reactor, the reactor comprising a core, a coolant tank containing coolant, and a fuel assembly moving unit, wherein:
the core comprises an array of fuel assemblies arranged in parallel rows, each fuel assembly comprising one or more fuel tubes containing fissile fuel and each fuel assembly being elongate in a direction perpendicular to the rows;
the fuel assembly moving unit is configured, for each row of the array:
remove one or more spent fuel assemblies from the array at a second end of the row;
to move fuel assemblies along the row from a first end to the second end; and
to introduce fuel assemblies to the array at a first end of the row;
such that:
each fuel assembly remains within a single row between introduction of the fuel assembly to the array and removal of the fuel assembly from the array; and
at least the fuel-filled portions of the fuel tubes of each fuel assembly are immersed in the coolant between introduction of the fuel assembly to the array and removal of the fuel assembly from the array.

10. A nuclear fission reactor according to claim 9, and comprising control blades, wherein the control blades are formed of a neutron absorbing material and are configured to be lowered between rows of the array in order to control a rate of nuclear reactions in the reactor.

11. A nuclear fission reactor according to claim 9, wherein the fuel assembly moving unit is configured to move fuel assemblies such that such that fuel assemblies in a first set of rows move in the opposite direction to fuel assemblies in a second set of rows.

12. A nuclear fission reactor according to claim 11, wherein the rows of fuel assemblies alternate between rows in the first set and rows in the second set, such that adjacent rows move in opposite directions.

13. A nuclear fission reactor according to claim 9, wherein each fuel assembly comprises a neutron moderator.

14. A nuclear fission reactor according to claim 13, wherein, for each fuel assembly, each fuel tube is adjacent to the neutron moderator.

15. A nuclear fission reactor according to claim 13, wherein, for each fuel assembly, each fuel tube is u-shaped, with a first vertical section adjacent to the neutron moderator and a second vertical section which is not adjacent to the neutron moderator.

16. A nuclear fission reactor according to claim 13, wherein, for each fuel assembly, the fuel tubes surround the neutron moderator.

17. A nuclear fission reactor according to claim 16, wherein, for each fuel assembly, the fuel tubes are arranged in layers around the neutron moderator.

18. A nuclear fission reactor according to claim 13, wherein, for each fuel assembly, the neutron moderator is clad in a material which resists corrosion by a molten salt coolant of the reactor.

19. A nuclear fission reactor according to claim 16, wherein, for each fuel assembly, the fuel tubes surrounding the neutron moderator are clad in a material which resists corrosion by a molten salt coolant of the reactor.

20. A nuclear fission reactor according to claim 18, wherein the material which resists corrosion is one of a metal alloy or a ceramic.

21. A nuclear fission reactor according to claim 13, wherein the neutron moderator comprises any one or more of:
carbon;
graphite;
zirconium hydride;
zirconium deuteride;
yttrium hydride;
yttrium deuteride;
lithium hydride;
lithium deuteride;
beryllium oxide.

22. A method according to claim 1, wherein the fuel assemblies comprise a neutron moderator.

23. (canceled)
